(19) United States
(12) Patent Application Publication
(10) Pub. No.: US 2023/0340914 A1
(43) Pub. Date: Oct. 26, 2023

(54) Turbine Powered Electricity Generation

(71) Applicant: Richard Alan Callahan, Isle La Motte, VT (US)

(72) Inventor: Richard Alan Callahan, Isle La Motte, VT (US)

(21) Appl. No.: 17/725,285

(22) Filed: Apr. 20, 2022

(51) Int. Cl. F01K 23/10; F01K 25/10; F25J 3/04

(52) U.S. Cl. CPC F01K 23/10; F01K 25/103; F25J 3/04533; F05D 2260/61; F05D 2220/72; F05D 2220/76

(57) ABSTRACT

A process is provided for separating syngas fuel into a CO-rich stream for feeding to oxyfuel combustor means of CO2 turbine means and a H2-rich stream for feeding to air-fuel gas turbine means for generating power provides opportunity to realize operating and equipment advantages.

### BACKGROUND OF THE INVENTION

All patents, patent applications and other publications referred to herein are specifically incorporated herein by reference in their entirety.

Among its many known uses, synthesis gas (syngas) can be used as the fuel in gas turbine driven power plants. Synthesis gas (syngas) is a gas mixture comprising primarily hydrogen (H₂), carbon monoxide (CO), water (H₂O) and carbon dioxide (CO₂), with minor amounts of other compounds (e.g., nitrogen, argon, hydrogen sulfide and methane). It can be produced by a number of known methods, including but not limited to coal gasification, steam methane reforming (SMR) and autothermal reforming (ATR).

In a gas turbine syngas is fed as a fuel together with air. There are three main turbine components:
1. An upstream axial rotating gas compressor section;
2. A downstream turbine expansion section on a common shaft with the compressor;
3. A combustion chamber or area, called a combustor, in between 1. and 2. above.

Atmospheric air flows through the compressor that brings it to higher pressure. Fuel is mixed with the air in a combustor wherein it is ignited to produce high temperature working fluid. In the case of syngas as fuel, energy is added by spraying syngas into the air and igniting it. This high-temperature high-pressure working fluid enters a turbine where it expands down to an exhaust pressure, producing shaft work output in the process. The turbine shaft work is used to drive the compressor; the energy that is not used to drive the compressor exits in the exhaust gases to produce thrust (power). The purpose of the gas turbine determines the design so that the most desirable split of energy between the thrust and the shaft work is achieved.

In the steam reforming process, a mixture of water and hydrocarbon, typically natural gas, are contacted at a high temperature, for example, in the range of about 850° to about 900° C., and typically in the presence of a catalyst, to form a mixture of hydrogen and carbon monoxide. Using methane as the hydrocarbon, the theoretical stoichiometry for the steam reforming reaction is as follows:

CH₄+H₂O [symbol] CO+3H₂

As illustrated in U.S. Pat. Nos. 9,782,718 and 3,965,675, a gas turbine can be combined with a steam turbine. In this “combined” system, hot exhaust from the gas turbine produces steam in a heat recovery steam generator for feeding as a working fluid to a steam turbine. In the combined system, each of the gas turbine and the steam turbine can be utilized to produce electricity.

Gas turbine power plants and combined gas turbine/steam turbine power plants known as combined cycle power plants (CC) can use the burning of fossil fuel to generate required heat. These systems have known drawbacks, for example harmful air emissions. Natural gas power plants (NGCC) produce large quantities of pollutants, especially carbon dioxide. Coal fired plants (IGCC) add sulfur oxides, mercury and fine particles. These drawbacks are typically addressed by adding expensive, energy-intensive equipment to reduce or clean up emissions after they are produced. However, the required systems degrade performance, reliability and increase the cost of electricity and the total cost of the power plant. They are expensive to build, complex and energy intensive.

For example, regarding IGCC coal-based plants, see “Commercial Power Production based on Gasification|netl . . . ”, https://www.netl.doe.gov>energy-systems>gasification>gasifipedia>igcc, [Retrieved Sep. 22, 2019], National Energy Technology Laboratory (NETL), wherein it states,

“Some important challenges to the wide-spread adoption of IGCC technology include cost, availability, and complexity. Cost is widely cited as the greatest barrier to IGCC acceptance. Capital costs for IGCC are high compared with alternative power plant designs, particularly NGCC, and financial viability is often dependent upon subsidies or tax credits. As a relatively new technology relative to PC and NGCC, development and design costs are much higher for IGCC. Availability also impacts operating costs and must be high enough to compete favorably with the conventional alternatives. The complexity of IGCC relative to older, more established plant designs also increases operating costs and can impact availability and the generation of capital for plant development. These challenges to gasification, with a focus towards IGCC, are discussed in the introductory discussion about gasification.” See also, “The Three Factors That Doomed Kemper County IGCC”, spectrum.ieee.org/energywise/energy/fossil-fuels/ . . . , Jun. 30, 2017, IEEE Spectrum, Retrieved Sep. 22, 2019.

In light of the noted problems related to IGCC power plants, and with the advent of relatively cheap natural gas, power plant companies are turning to NGCC power plants. Since natural gas (NG) became readily available as fuel for gas turbines, it was fed directly to the combustion chamber. A non-limiting illustrative example of an NGCC power plant is schematically shown in FIG. 1.

With reference to FIG. 1, reference numeral 1 generally refers to a gas turbine generator for producing power. Gas turbine 1 comprises compression section 103, expansion section 102 and combustor section 104 shown therebetween. Air stream 106 is fed to compression section 103. Natural gas stream 105 is fed to combustor section 104 wherein it is combusted with compressed air stream 107 to produce gas turbine working fluid 108. Gas turbine working fluid 108 flows to expansion section 102 wherein the expanding working fluid produces power for operating compressor section 103 and an electricity generator 109. Gas turbine exhaust 110 flows to heat exchanger 111 wherein exhaust stream 110 is cooled by indirect heat exchange with circulating water stream 113. Cooled exhaust stream 110 is vented to the atmosphere in vent stream 112. Circulating water stream 113 is heated to produce steam stream 114. Steam stream 114 then flows to a steam turbine 115 that produces power to operate electricity generator 116. After expansion in steam turbine 115, stream 117 flows to condenser 118 wherein stream 117 is condensed to water. The water stream 17a exiting condenser 118 is then recycled to heat exchanger 111 by pump 119.

The present invention relates to a novel process for operating NGCC power plants. According to an embodiment, the process comprises:
a. feeding natural gas from a first natural gas source to syngas converting means for converting natural gas to syngas,
b. feeding a separator feedstream comprising the syngas to membrane separator means,
c. separating the separator feedstream in the separator means to form a first, CO-rich stream and a second, H₂-rich stream,
d. feeding the first, CO-rich stream as an oxyfuel combustor feedstream to oxyfuel combustor means for forming sub-critical CO₂ gas turbine working fluid, and
e. feeding the sub-critical CO₂ gas turbine working fluid to gas turbine means for producing power,
f. wherein the sub-critical CO₂ gas turbine working fluid exits the gas turbine means as gas turbine exhaust which is fed to heat recovery steam generator means for generating steam, and wherein steam from the heat recovery steam generator means is fed as first steam working fluid to first steam turbine means for generating power,
g. wherein at least a first portion of exhaust from the gas turbine is recycled as feed to the oxyfuel combustor means together with high purity oxygen and the first, CO-rich stream,
h. wherein the second, H₂-rich stream is fed as an air-fuel combustor feedstream to air-fuel combustor means for forming air-fuel gas turbine working fluid, and wherein the air-fuel gas turbine working fluid is fed to air-fuel gas turbine means for producing power, and
i. wherein supplemental natural gas is added to the first, CO-rich stream.
   In the context of the standard NGCC power plant systems that feed natural gas directly to the gas turbine combustor, converting the natural gas to syngas and further separating the syngas to a first, CO-rich stream and a second, H₂-rich stream was found to result in unexpected operating efficiencies and advantages as will become clear from this disclosure.

According to another embodiment, the process comprises:
a. feeding natural gas from a first natural gas source to syngas converting means for converting natural gas to syngas,
b. feeding a separator feedstream comprising syngas from natural gas to separator means,
a. separating the separator feedstream in the separator means to form a first, CO-rich stream and a second, H₂-rich stream,
c. feeding the first, CO-rich stream as an oxyfuel combustor feedstream to oxyfuel combustor means for forming sub-critical CO₂ gas turbine working fluid,
d. feeding the sub-critical CO₂ gas turbine working fluid to sub-critical CO₂ gas turbine means, the sub-critical CO₂ gas turbine means having a sub-critical CO₂ gas turbine expansion section and a sub-critical CO₂ gas turbine compression section, the sub-critical CO₂ gas turbine working fluid being fed to the sub-critical CO₂ gas turbine expansion section for producing power,
e. recycling at least a first portion of exhaust from the sub-critical CO₂ gas turbine expansion section together with high purity oxygen to the sub-critical CO₂ gas turbine compression section of the sub-critical CO₂ gas turbine means, wherein the power produced in step (d) is used to power the sub-critical CO₂ gas turbine compression section to compress the recycled sub-critical CO₂ gas turbine exhaust,
f. capturing the remaining portion of sub-critical CO₂ gas turbine exhaust,
g. feeding the compressed sub-critical CO₂ gas turbine exhaust to the oxyfuel combustor means,
h. reacting the first, CO-rich stream with high purity oxygen in the oxyfuel combustor means under sub-critical CO₂ conditions,
feeding the second, H₂-rich stream as an air-fuel combustor feedstream to air-fuel combustor means wherein the air-fuel combustor feedstream is reacted with air to form an air-fuel gas turbine working fluid,
j. feeding the air-fuel gas turbine working fluid to air-fuel gas turbine means, the air-fuel gas turbine means having an air-fuel gas turbine expansion section and an air-fuel gas turbine compression section, the air-fuel gas turbine working fluid being fed to the of air-fuel gas turbine expansion section for producing power,
k. feeding air to the air-fuel gas turbine compression section of the air-fuel gas turbine means, wherein the air is compressed using the power produced in step (j),
l. feeding the compressed air to the air-fuel combustor means for reaction with the second, H₂-rich stream to form the air-fuel gas turbine working fluid,
m. wherein before recycling exhaust from the sub-critical CO₂ gas turbine expander section to the sub-critical CO₂ gas turbine compression section of the sub-critical CO₂ gas turbine means, the exhaust is fed to first heat recovery steam generator means for generating steam,
n. wherein steam from the first heat recovery steam generator means is fed to first steam turbine means for generating power,
o. wherein exhaust from the air-fuel gas turbine means is fed to second heat recovery steam generator means for generating steam,
p. wherein steam from the second heat recovery steam generator means is fed to second steam turbine means for generating power. and
q. wherein supplemental natural gas is added to the first, CO-rich stream.

According to a further embodiment, the process comprises:
a. feeding a separator feedstream comprising syngas from natural gas to membrane separator means,
b. separating the separator feedstream in the separator means to form a first, CO-rich stream and a second, H₂-rich stream,
c. feeding the first, CO-rich stream as an oxyfuel combustor feedstream to oxyfuel combustor means for forming sub-critical CO₂ gas turbine working fluid, and
d. feeding the sub-critical CO₂ gas turbine working fluid to gas turbine means for producing power,
e. wherein the sub-critical CO₂ gas turbine working fluid exits the gas turbine means as gas turbine exhaust which is fed to heat recovery steam generator means for generating steam, and wherein steam from the heat recovery steam generator means is fed as first steam working fluid to first steam turbine means for generating power,
f. wherein at least a first portion of exhaust from the gas turbine is recycled as feed to the oxyfuel combustor means together with high purity oxygen and the CO-rich stream,
g. wherein the second, H₂-rich stream is fed as a H₂ feedstream to treatment means for increasing the H₂ purity of the H₂ feedstream, and
h. wherein supplemental natural gas is added to the first, CO-rich stream.

### BRIEF DESCRIPTION OF THE DRAWINGS

FIG. 1 is a schematic diagram of a convention al NGCC power plant using natural gas as the combustor fuel.

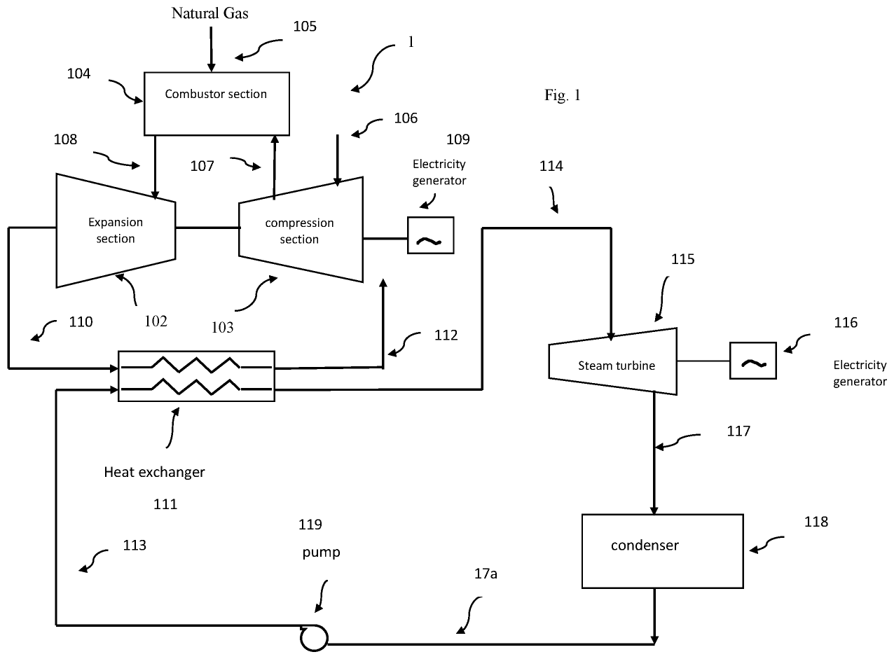

FIG. 2 is a schematic diagram of a NGCC power plant using separated syngas as fuel for a combined cycle power plant.

### DETAILED DESCRIPTION OF THE INVENTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein.

All publications, patents and patent applications cited herein, whether supra or infra, are hereby incorporated herein by reference in their entirety to the same extent as if each individual publication, patent or patent application was specifically and individually indicated to be incorporated herein by reference. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, as well as, any range formed within a specified range, regardless of whether ranges are separately disclosed. Where a range of numerical values is recited herein, unless otherwise stated, the range is intended to include the endpoints thereof, and all integers and fractions within the range. For example, recitation of 1-5 is intended to include all integers including and between 1 and 5 and all fractions and decimals between 1 and 5, e.g., 1, 1.1, 1.2, 1.3 etc. It is not intended that the scope of the invention be limited to the specific values recited when defining a specific range. Similarly, recitation of at least about or up to about a number is intended to include that number and all integers, fractions and decimals greater than or up to that number as indicated. For example, at least 5 is intended to include 5 and all fractions and decimals above 5, e.g., 5.1, 5.2, 5.3 etc.

It is noted that, as used in this specification and the appended claims, the singular forms “a,” “an” and “the” include plural referents unless the content clearly dictates otherwise. Unless otherwise expressly indicated herein, all amounts are based on volume.

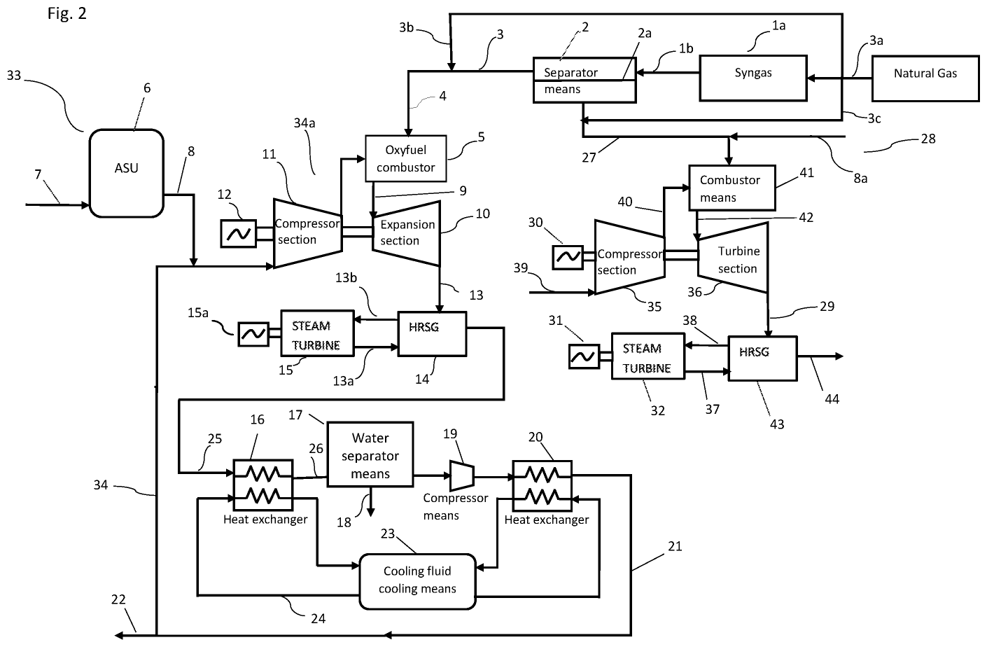

With reference to illustrative FIG. 2 of the drawings, la is a source for converting natural gas 3a to syngas, for example, by steam methane reforming (SMR) or autothermal (reforming). See, for example, U.S. Pat. Nos. 3,479,298, 5,653,774, 6,340,437, 7,481,856, 4,415,484, 7,592,290 and 5,628,931. Steam reforming of natural gas can proceed in tubular reactors that are heated externally. The process uses nickel catalyst on a special support that is resistant against the harsh process conditions. Waste heat from the heating section is used to preheat gases and to produce steam. Partial oxidation of methane is a non-catalytic, large-scale process to make syngas. A catalytic version of partial oxidation (CPO), based on short-contact time conversion of methane, on e.g. rhodium catalysts, is suitable for small-scale applications. Autothermal reforming (ATR) is a hybrid, which combines methane steam reforming and oxidation in one process. The heat needed for reforming is generated inside the reactor by oxidation of the feed gas.

Syngas feed compositions are well known in the art and can vary depending on the source. By way of nonlimiting example, it is believed that syngas feed 1b can comprise H₂, CO₂, CO, CH₄ and H₂O in the following amounts. The H₂ content can be about 20-65%. The CO₂ content can be about 2-25%. The CO content can be about 20-60%. The H₂O content can be about 5-40%. The CH₄ content can typically be about 0.1%-0.9%. It is understood that the syngas feed 1b may contain minor amounts of contaminants, e.g., H₂S, NH₃, HCl, COS, and Hg, depending whether the syngas is gasified coal or reformed natural gas, and can be removed by known treatments. By way of example, contaminants could comprise less than about 0.5% of syngas feed 1b.

Separator means 2 can be any known separator means suitable for the purpose of separating the syngas feedstream into a first, CO-rich stream 3 and a second, H₂-rich stream 27. For example, separator means can be membrane separator means or pressure swing adsorption means. Membrane separation is preferred.

Gas separation membranes and the operation thereof for separating gas mixtures are well known. See for example, U.S. Pat. No. 5,482,539. U.S. Pat. Nos. 4,990,168, 4,639,257, 2,966,235, 4,130,403, 4,264,338, and 5,102,432. Any known membrane that is operable under the conditions of operation to meet the noted product compositions can be used. For example, Ube membranes and Generon® membranes advertised for H₂ separations would be suitable, as would apolybenzimidazole (PBI) membrane. Reference is made, respectively, to Haruhiko Ohya et al, “Polyimide Membranes: Applications, Fabrications and Properties” by H. Ohya, V. V. Kudryavtsev and S. I, Semenova (Jan. 30, 1997) co-published by Kodansha LYD., 12-21 Otowa 2-Chome Bunkyo-Ku, Tokyo 112, Japan and Gordan and Breach Science Publishers S.A. Emmaplein 5, 1075 AW Amsterdam, The Netherlands, for the Ube membranes and to Jayaweera, Indira S. “Development of Pre-Combustion CO₂ Capture Process Using High-Temperature Polybenzimidazole (PBI) Hollow-Fiber Membranes (HFMs)”, 2017 NETL CO₂ Capture Technology Project Review Meeting, Aug. 21-25, 2017, [online] [retrieved Jan. 17, 2019], [https://www.netl.doe.gov/sites/default/files/2017-12/2I-S-Jayaweera2-SRI-PBIHollow-Fiber-Membranes.pdf], and “Celazole® PBI”, [online] [retrieved Jan. 17, 2019], [https://pbipolymer.com/markets/membrane/].

As illustrated in FIG. 2, separator means 2 comprises membrane means 2a disposed therewithin. The syngas feedstream is fed to separator means on one side of the membrane means and is separated into separate streams by selective permeation of syngas components therethrough. As shown, the membrane is more permeable to the H₂ contained in the syngas feedstream than it is to CO. The membrane being more selective for H₂ permeation, permeate stream 27 is enriched in H₂ as compared to syngas feedstream 1b, and retentate stream 3 is enriched in CO as compared to the syngas feedstream 1b. Accordingly, stream 27 comprises a H₂-rich stream and stream 3 comprises a CO-rich stream. The CO-rich stream is then sent to a sub-critical CO₂ power plant 33.

Concepts of mixed-gas separation, gas permeability and selectivity are discussed in a number of publications, including “Materials Science of Membranes for Gas and Vapor Separation”, Edited by Yampolski et al, 2006 JohnWiley & Sons; “Pure and mixed gas CH₄ and n-C₄H₁₀ permeability and diffusivity in poly(l-trimethylsilyl-1-propyne)” Roy D. Raharjo et al, Polymer 48 (2007) 7329-7344, 2006 Elsevier Ltd., “Carbon Dioxide Separation through Polymeric Membrane Systems for Flue Gas Applications”, Colin A. Scholes et al, Cooperative Research Centre for Greenhouse Gas Technologies, Department of Chemical and Biomolecular Engineering, The University of Melbourne, VIC, 3010, Australia; and “Recent Patents on Chemical Engineering”, 2008, 1 52-66, 2008 Bentham Science Publishers Ltd.

The CO-rich stream 3 comprises primarily CO, with minor amounts of carbon dioxide and hydrogen.

After optional contaminant removal (not shown), stream 3 should comprise primarily CO and hydrogen. Stream 3 can also comprise a small amount of CO₂ and traces of remaining contaminants. For example, stream 3 can comprise at least about 35%, or at least about 50%, or at least about 65%, or at least about 80% CO. Having the benefit of the disclosure of the present invention, it is seen that the H₂ content of stream 3 depends on operational and plant design objectives. On that basis, it is believed that the stream 3 should comprise less than about 55%, or less than about 40%, or less than about 25%, or less than about 10% H₂. Stream 3 can also comprise a small amount of CO₂ and traces of remaining contaminants. Stream 3 should comprise less than about 0.01%, or less than about 0.001%, or less than about 0.0001%, or less than about 0.00001% of contaminants; and CO₂ should comprise less than about 25%, or less than about 15%, or less than about 10%, or less than about 5% of stream 3. Any upper limit for the CO content of stream 3 is considered to be limited only by the ability of technology to economically enrich stream 3 in CO. It is believed that using present technology, stream 3 can comprise up to about 90-95% CO.

Stream 3 is then fed as oxyfuel combustor feedstream 4 to oxyfuel combustor means 5, wherein it is combined and reacted with high purity oxygen stream 8 of at least about 95% purity from air separation unit means 6 for separating oxygen from air following compression in gas turbine compressor section 11 as shown at 34a. As shown in FIG. 2, stream 4 is fed directly (other than any optional contaminant removal) to oxyfuel combustor means 5. For example, stream 4 is fed to the oxyfuel combustor means 5 in FIG. 2 (in the absence of any intervening process step, e.g., expansion in an expander to lower pressure. The oxygen content of stream 8 comprises at least about 95%, at least about 97%, at least about 99%, or at least about 99.5%. As discussed in detail below, sub-critical CO₂ exhaust stream 34, after compression in compressor section 11, is also fed to combustor means 5. Oxygen stream 8 can be premixed with sub-critical CO₂ exhaust stream 34 either upstream of compression section 11 or in situ within combustor means 5. Means for premixing in situ are known in the art. For example, see Delimont, Jacob et al, “Direct Fired Oxy-Fuel Combustor for sCO2 Power Cycles, February 2018 Oxy-fuel Working Group presentation, [online] [retrieved Aug. 13, 2019], [https://www.netl.doe.gov/sites/default/files/netl-file/sCO2-WorkingGroup-Feb2018_1MWOxyCombustor.pdf].

Air separation units are well known, for example, as illustrated in U.S. Pat. Nos. 2,548,377, 4,531,371 and 4,382,366. See also, Rong Jiang, Analysis and Optimization of ASU for Oxyfuel Combustion [online] [retrieved Feb. 19, 2019] [http://ieaghg.org/docs/General_Docs/5oxy%20presentations/Session%207B/7B-05%20-%20R.%20Jiang %20(SASPG%20Ltd.).pdf], and “History and progress in the course of time, [online] [retrieved Feb. 19, 2019] [https://www.linde-engineering.com/en/images/Air_separation_plants_History_and_progress_in_the_course_of time_tcm19-457349.pdf]. Before the use of a separator means to separate hydrogen from the syngas feedstream 1b in accordance with the present invention, a considerable portion of the oxygen produced in prior air separation units was consumed by reaction with H₂ contained in the combustor fuel stream 4. Combustion in accordance with an embodiment of the present invention, results in stream 9 comprised primarily of CO₂ working fluid with a substantially reduced amount of steam. The CO₂ content of the oxyfuel combustion exhaust in stream 9 will, of course, vary, depending on the amount of H₂ recovery in the membrane permeate and the amount of CO₂ in the membrane feedstream both of which affects the CO₂ content in the CO₂ oxyfuel combustion exhaust. In any event, it can comprise at least about 50%, at least about 60% at least about 70%, or at least about 80% CO₂, with the balance comprising H₂O, and contaminants such as N₂+Ar.

Sub-critical CO₂ 9 formed in combustor means 5 is then fed to the expansion section 10 of sub-critical CO₂ turbine means wherein power is produced to power compression section 11 and electricity generator 12. Expanded sub-critical CO₂ exhaust 13 is then fed to known heat recovery steam generator means (HRSG) 14, wherein exhaust 13 indirectly heats a water stream (not shown) to produce working fluid steam stream 13b. The working fluid steam stream 13b is fed to a first, known steam turbine means 15 that powers electricity generator 15a. Condensed steam stream 13a is recycled back to the HRSG 14.

Sub-critical CO₂ exhaust 25 from HRSG 14 is then fed to heat exchanger cooling means 16 for indirect cooling with cooling fluid 24. Cooled sub-critical CO₂ stream 26 is sent to condensed water separator means 17 for removing condensed water 18 from cooled sub-critical CO₂ stream 26. Since stream 26 comprises less water due to the separation of hydrogen from stream 1b by separator means 2, cooling means 23 energy and equipment size requirements can be significantly reduced. Cooling fluid 24 for heat exchangers 16 and 20 is provided by known cooling fluid cooling means 23. The sub-critical CO₂ working fluid leaving the water separator 17, is compressed in CO₂ compressor means 19, and then cooled in aftercooler heat exchanger means 20 to remove heat of compression. Compressed and cooled sub-critical CO₂ stream 21 is then circulated for at least partial capture in stream 22 and recirculation in stream 34 and then forwarded back to oxyfuel combustor means 5. As shown in FIG. 2, at least a first portion 34 of recycle stream 21 is recycled to oxyfuel combustor means 5 and a second portion 22 is captured for storage or further use, for example, in enhanced oil recovery. Recycle stream 34 is a working fluid for the optimum performance of the sub-critical CO₂ oxyfuel combustor 5 and the sub-critical CO₂ turbine shown at 10 and 11. Recycling the sub-critical CO₂ to oxyfuel combustor means 5 enables the sub-critical CO₂ power cycle to operate with sub-critical CO₂ as the working fluid in the gas turbine. The cycle is operated below the critical point of CO₂.

Permeate, H₂-rich gas stream 27 is fed, with compression (not shown) as required, to a combined cycle system 28. Stream 27 comprises primarily H₂ with small quantities of CO₂, CO and trace quantities of H₂O. Stream 27 can comprise at least about 40%, or at least about 50% H₂ or at least about 60%, or at least about 85% H₂. Having the benefit of the disclosure of the present invention, it is seen that the CO content of stream 27 depends on operational and plant design objectives. On that basis, it is believed that stream 27 should comprise less than about 10% CO, or less than about 5% CO, or less than about 3% CO, or less than about 1% CO with the balance comprising other components such as CO₂ and H₂O. Any upper limit for the H₂ content of stream 27 is considered to be limited only by the ability of technology to economically enrich stream 27 in H₂. It is believed that using present technology, stream 27 can comprise up to about 90-95% H₂. As shown in FIG. 2, gas stream 27 can be premixed with inert diluent stream 8a. This, for example, can add combustion benefits to air-fuel combustor means 41 by adjusting the flammability limit and heating value of the feedstream to combustor means 41. Any known inert diluent can be used such as, by way of nonlimiting example, N₂, steam or CO₂. In the present process N₂ byproduct from air separation unit 6 is readily available to supply stream 8a for this purpose. If needed, a portion of CO₂ or steam from other parts of the process could be used to supply or supplement N₂ in diluent stream 8a.

Instead of H₂-rich gas stream 27 being fed to a combined cycle system 28, stream 27 can be fed to any known process, for example by pressure swing adsorption or palladium proton membrane treatment, for further enrichment to high purity H₂ and further use. By way of non-limiting example, the high purity H₂ can be used for
1. Zero emission transportation fuel in an internal combustion engine or in a fuel cell to power an electric motor,
2. Gas welding,
3. Hydrotreating to remove sulfur in petroleum refining,
4. Chemicals production,
5. Generation of electricity,
6. As a reducing agent,
7. Potentiometry and Chemical analysis,
8. In gas chromatography, or
9. Rocket fuel for space programs
   As shown in FIG. 2, gas stream 27 is fed as an air-fuel combustor feedstream to air-fuel combustor means 41 of a known air-fuel gas turbine means comprising known turbine compressor section 35 and expansion section 36. As shown, working fluid air stream 39 is fed to compressor section 35. Compressed air stream 40 is fed to combustor means 41 wherein the compressed air and fuel gas stream 27 are mixed and combusted to form gas turbine working fluid 42. Working fluid 42 is then fed to expansion section 36 of the air-fuel gas turbine means wherein the working fluid expands, producing power which, in turn, drives electricity generator 30 and compressor section 35. Expanded exhaust 29 is then fed to known heat recovery steam generator means (HRSG) 43, wherein exhaust 29 indirectly heats a water stream to produce steam stream working fluid 38. The steam working fluid 38 is fed to known steam turbine means 32 that powers electricity generator 31. Condensed steam stream 37 is recycled back to the HRSG 43.

While known air-fuel gas turbines typically burn carbonaceous fuels (e.g., natural gas or syngas) mixed with air to form a working fluid, processes in accordance with the present invention burn primarily H₂ with substantially reduced percentages of CO₂ and CO, and thus little or virtually no carbon dioxide is exhausted to the ambient environment in stream 44.

Referring to FIG. 2, the first CO rich retentate stream 3 and the second hydrogen rich permeate stream 27 have, i.e. about 30% of the heating value of natural gas (Btu per cubic foot). Therefore, the CO rich retentate stream 3 and the hydrogen rich permeate stream 27 need higher, up to about three times higher volumetric flow rate than natural gas to deliver the same net heat rate (Btu/hr/kW) to the gas turbine. According to an embodiment, supplemental natural gas can be added to the CO rich retentate stream 3 and/or the hydrogen rich permeate stream 27 to increase the heating value thereof. As shown in FIG. 2 by way of a non-limiting illustrative example, supplemental gas can be supplied from natural gas feed 3a as a slip stream 3b to retentate stream 3 and/or slip stream 3c to permeate stream 27. Optionally, the supplemental natural gas can be provided from an independent source separate from slip streams 3b and 3c. Blending natural gas with the CO rich retentate stream 3 or the hydrogen rich permeate stream 27 increases heating value and decreases volumetric flow rate enabling a smaller increase in gas volumetric flow rate to the gas turbine.

### EXAMPLES

Below are nonlimiting illustrative Examples

### Example 1

Example 2 presents a comparison of a 150 MWe (megawatts as an electric energy rate) NGCC power plant with the same plant retrofitted according to an embodiment of the invention previously described. In the 150 MWe NGCC plant pipeline natural gas is directed into the plant's combined cycle power train at the rate of 250 MWth wherein it is combusted with air and converted at 60% thermal efficiency to 150 MWe.

In the retrofitted 150 MWe NGCC power plant the 250 MWth (megawatts as a thermal energy rate) pipeline natural gas is first directed to a steam methane (CH₄) reformer wherein CH₄ is reformed into syngas according to the stoichiometric reaction:

$${{HHV}_{Btu / cf} : {{CH}_{4}}_{1013.1} + {{H}_{2} O}_{0} + {Q - {RXN}^{*}}_{285.2} \to {CO}_{320.6} + {3 {H}_{2}}_{3 \times 325.9}}_{\begin{matrix}* Heat of reaction calculated by difference from equation \\ energy balance\end{matrix}}$$

Since the reaction is endothermic, the Q-RXN (heat of reaction) is calculated by difference to satisfy the following energy balance:

| | |
|---|---|
| Thermal energy input | Thermal energy output |

| | | | | | |
|---|---|---|---|---|---|
| CH₄ | 1013.1 | Btu/cf | CO | 320.6 | Btu/cf |
| Q-RXN | 285.2 | Btu/cf | 3H₂ | 977.7 | Btu/cf |
| | 1298.3 | Btu/cf | | 1298.3 | Btu/cf |

Reforming CH₄ is 100% energy efficient. Stoichiometrically the syngas thermal energy is 28% greater than the natural gas thermal energy according to the ratio 1,298.3/1,013.1=1.28. Therefore, according to the block flow diagram, the thermal energy produced in the reformer is 28% greater than the thermal energy supplied by the pipeline, i.e., 320.4 MWth/250 MWth=1.28. The syngas produced in the reformer is next directed to a gas separation unit wherein the syngas is separated into a 79.1 MWth CO rich stream and a 241.3 MWth H₂ rich stream. The CO rich stream is then directed to a new oxyfuel combined cycle power train wherein 47.5 MWe electric power is produced at 60% thermal conversion efficiency. The H₂ rich stream is then directed to the existing air-fuel combined cycle power train wherein 144.8 MWe electric power is produced at 60% thermal conversion efficiency. The total electric power output of 192.2 MWe is 1.28 times greater than the 150 MWe electric power output produced by the un-retrofitted NGCC power plant. The cash flow generated by the additional 42.2 MWe of electric power output from the retrofitted plant can amortize the fixed capital costs of the reformer, the gas separation unit, oxyfuel combined cycle and the air separation unit. Instead of having a parasitic power load to capture CO₂, the present invention generates additional power while capturing CO₂.

The methane reformer energy balances are further described and explained at the following website: https://inside.mines.edu/ljechura/EnergyTech/07_Hydrogen_from_SMR.pdf
In a summary table below, the retrofitted NGCC power plant has the following characteristic power plant heat rates:

Retrofitting a 150 MWₑ 60% Efficient NGCC Power Plant
with a NG Reformer to Increase Net Power Output by 28%:

| Gas Fuel | Heat rate | unit | Qₜₕ* | MWₜₕ | MWₑ |
|---|---|---|---|---|---|
| Pipeline NG in | 853,000,000 | Btu/h | 1.000 | 250.0 | 150.0 |
| Reformer CO out | 269,935,643 | Btu/h | 0.316 | 79.1 | 47.5 |
| Reformer H₂ out | 823,194,255 | Btu/h | 0.965 | 241.3 | 144.8 |
| Total reformer | 1,093,129,898 | Btu/h | 1.28 | 320.4 | 192.2 |
| CO + H₂ out | | | | | |
| Total reformer | 1.28 | | 1.28 | 1.28 | 1.28 |
| out/pipeline in | | | | | |

*Unitary thermal power

### Example 2

A detailed explanation of the chemistry involved in converting natural gas to syngas by reforming natural gas in a steam methane reformer (SMR) or auto-thermal reformer (ATR) is given below:

Reforming Natural Gas is 100% Energy Efficient

$${{HHV}_{Btu / cf} : {{CH}_{4}}_{1013.1} + {{H}_{2} O}_{0} + {Q - {RXN}^{*}}_{285.2} \to {CO}_{320.6} + {3 {H}_{2}}_{3 \times 325.9}}_{* Fuel reaction heat input from equation energy balance}$$

### Conversion Efficiency HHV Basis

Production: (N_{CO}+NH₂)/N_{CH4}=4 mol/mol
Just from stoichiometry: η=(320.6+3×325.9)/(1×1013.1)=1.28
Include heat of reaction: η=(320.6+3×325.9)/(1×1013.1+285.2)=1.00

### Use Additional CH₄ to Provide Q-RXN

Additional CH₄ fuel: 0.282 mol CH₄ fuel/mol CH₄ reactant
Production: (N_{CO}+NH₂)/N_{CH4}=4/(1+0.282)=3.12 mol/mol
Efficiency including fuel: η=(320.6+3×325.9)/(1.282×1013.1)=1.00
   In other words, the thermal energy balance in Btu/cf for the reformer's endothermic reaction is 100% efficient:

| | |
|---|---|
| Energy input | Energy output |

| | | | |
|---|---|---|---|
| CH₄ | 1013.1 | CO | 320.6 |
| CH₄ Q-RXN | 285.2 | 3H₂ | 977.7 |
| | 1298.3 | | 1298.3 |

Stoichiometric energy ratio=[320.6+3×(325.9)]/1013.1=1.2815
Conservation of energy requires CH₄ Q-RXN=0.2815×1013.1=285.2
   For example: A NGCC power plant with a name plate output of 150 MWe burns NG in three 50 MWe combined cycle power trains. If the NG is reformed into syngas and the syngas is separated into a H₂ rich fuel and a CO rich fuel, then the three existing combined cycle power trains burning the H₂ rich fuel generate 144.759 MWe and a new combined cycle power train burning the CO rich fuel generates 47.468 MWe. The new power output is 192.227 MWe which is 28.15% greater that the original name plate output of 150 MWe. This increase in output balances against the NG fuel required for Q-RXN to reform the NG into syngas. Retrofitting an existing NGCC power to use separated syngas made from reformed NG increases MWe output by 28.15% and is 100% thermal energy efficient.

### Example 3

TABLE 3
UBE Industries, Ltd., Polyimide Membrane H₂ and CO
Permeability and Selectivity vs. Temperature Data

| 1000 T⁻¹(K)⁻¹ | | | selectivity | GPU¹ | GPU¹ | GPU² | GPU² | Barrer³ | Barrer³ |
|---|---|---|---|---|---|---|---|---|---|
| ° F. | x | ° C. | H₂/CO | H₂ | CO | H₂ × 10⁻⁶ | CO × 10⁻⁶ | H₂ (×10⁻¹⁰) | CO (×10⁻¹⁰) |
| 77.91 | 3.35 | 25.51 | 134.78 | 0.31 | 0.002 | 4.135 | 0.031 | 4.135 | 0.0307 |
| 140.60 | 3.00 | 60.33 | 100.00 | 0.80 | 0.008 | 10.671 | 0.107 | 10.671 | 0.1067 |
| 207.27 | 2.70 | 97.37 | 75.95 | 1.80 | 0.024 | 24.010 | 0.316 | 24.010 | 0.3161 |
| 260.60 | 2.50 | 127.00 | 65.00 | 2.60 | 0.040 | 34.681 | 0.534 | 34.681 | 0.5336 |

| | | | |
|---|---|---|---|
| 212.00 | 2.68 | 100.00 | 74.88 UBE membrane maximum operating temperature is 100° C. |

¹P/I (mm³/s/m²/Pa) Selectivity for 100° C. calculated by equation
²P/I (cm³/s/cm²/cm Hg)
³P (cm³ − cm)/s/cm²/cm Hg) when I = 0.0001 cm membrane thickness
Source: Polyimide Membranes-Applications, Fabrication, and Properties by Haruhiko Ohya, Vladislav V. Kudryavtsev and Svetlana I. Semenova (Jan. 30, 1997) page 250 Gordan and Breach Science Publishers S.A., Emmaplein 5, 1075AW Amsterdam, The Netherlands Pg. 250, FIG. 6.7, Temperature of pure gas permeation rates through asymmetric polyimide hollow fiber membrane . . . by UBE Industries, Ltd. (From Haraya, K. et al., Gas Separation and Purification, 1, 4 (1987))

TABLE 4
UBE Industries, Ltd., Polyimide Membrane H₂ and
CO₂ Permeability and Selectivity vs. Temperature Data

| 1000 T⁻¹(K)⁻¹ | | | selectivity | GPU¹ | GPU¹ | GPU² | GPU² | Barrer³ | Barrer³ |
|---|---|---|---|---|---|---|---|---|---|
| ° F. | x | ° C. | H₂/CO₂ | H₂ | CO₂ | H₂ × 10⁻⁶ | CO₂ × 10⁻⁶ | H₂ (×10⁻¹⁰) | CO₂ (×10⁻¹⁰) |
| 77.91 | 3.35 | 25.51 | 6.89 | 0.31 | 0.045 | 4.135 | 0.600 | 4.135 | 0.6003 |
| 140.60 | 3.00 | 60.33 | 8.00 | 0.80 | 0.100 | 10.671 | 1.334 | 10.671 | 1.3339 |
| 207.27 | 2.70 | 97.37 | 8.82 | 1.80 | 0.204 | 24.010 | 2.721 | 24.010 | 2.7212 |
| 260.60 | 2.50 | 127.00 | 9.29 | 2.60 | 0.280 | 34.681 | 3.735 | 34.681 | 3.7349 |

| | | | |
|---|---|---|---|
| 212.00 | 2.68 | 100.00 | 9.97 UBE membrane maximum operating temperature is 100° C. |

¹P/I (mm³/s/m²/Pa) Selectivity for 100° C. calculated by equation
²P/I (cm³/s/cm²/cm Hg)
³P (cm³ − cm)/s/cm²/cm Hg) when I = 0.0001 cm membranw thickness
Source: Polyimide Membranes-Applications, Fabrication, and Properties by Haruhiko Ohya, Vladislav V. Kudryavtsev and Svetlana I. Semenova (Jan. 30, 1997) page 250 Gordan and Breach Science Publishers S.A., Emmaplein 5, 1075AW Amsterdam, The Netherlands, Pg. 250, FIG. 6.7, Temperature of pure gas permeation rates through asymmetric polyimide hollow fiber membrane . . . by UBE Industries, Ltd. (From Haraya, K. et al., Gas Separation and Purification, 1, 4 (1987))

In Tables 3 and 4, UBE Industries, Ltd. (UBE) is a Japanese multinational manufacturer of polyimide hydrogen separation membranes and have supplied membranes globally to industry for many years.

H₂ and CO permeability values versus temperature are presented in Table 3 and H₂ and CO₂ permeability values are presented in Table 4. The GPU unit, also known as permeance, is a pressure normalized steady state flux for a given membrane thickness and is given as volumetric flow per unit area per second per unit differential pressure across the membrane. The Barrer unit, also known as permeability, is a steady state flux normalized for both membrane thickness and pressure differential across the membrane and is given as volumetric flow times membrane thickness, per unit area per second per unit differential pressure across the membrane. Selectivity is the ratio of the respective GPU or Barrer units, e.g., H₂/CO selectivity at 97.37° C. of 75.95 is determined by following ratio:

24.1010 cm³/cm²/s/cm Hg divided by 0.316³/cm²/s/cm Hg=75.95

It can be seen from the Tables 3 and 4 that H₂/CO selectivity is more sensitive to temperature change than H₂/CO₂ selectivity. The maximum operating temperature for the UBE polyimide membrane is 150° C. Operating an UBE polyimide membrane separator means at the maximum temperature of 150° C. increases overall system thermal efficiency. Further, the trendline equation in Table 3 calculates a H₂/CO selectivity of 63.33 at 150° C., a selectivity reduction of only 2.6% compared with 127° C. Furthermore, based a trendline algorithm for temperature vs. H₂ GPU values in Table 3, H₂ GPU is increased by about 30% at 150° C. compared with 127° C. In general, mixed gas selectivity will be lower than pure gas selectivity.

### Example 4

TABLE 5
SRI International, Polybenzimidazole (PBI) Membrane H₂, CO and
CO₂ mixed gas Permeability and Selectivity vs. Temperature Data

| | | selectivity | GPU¹ | GPU¹ | Barrer² | Barrer² |
|---|---|---|---|---|---|---|
| ° F. | ° C. | H₂/CO | H₂ × 10⁻⁶ | CO × 10⁻⁶ | H₂ (×10⁻¹⁰) | CO (×10⁻¹⁰) |
| 437.00 | 225.00 | 103.0 | 80.0 | 0.775 | 80.0 | 0.775 |

¹P/I (cm3/s/cm2/cm Hg)
²P (cm³ − cm)/s/cm²/cm Hg) when I = 0.0001 cm membrane thickness

| | | selectivity | GPU¹ | GPU¹ | Barrer² | Barrer² |
|---|---|---|---|---|---|---|
| ° F. | ° C. | H₂/CO₂ | H₂ × 10⁻⁶ | CO₂ × 10⁻⁶ | H₂ (×10⁻¹⁰) | CO₂ (×10⁻¹⁰) |
| 437.00 | 225.00 | 40.0 | 80.0 | 2.00 | 80.0 | 2.00 |

¹P/I (cm3/s/cm2/cm Hg)
²P (cm³ × cm)/s/cm²/cm Hg) when I = 0.0001 cm membrane thickness
PBI DATA:
The PBI data in Table 4 is available at: https://www.netl.doe.gov/sites/default/files/2017-12/2I-S-Jayaweera2-SRI-PBI-Hollow-Fiber-Membranes.pdf

### Example 5

Non-limiting examples of mixed gas selectivity concentrations of the first separated CO-rich stream and the second separated H₂-rich stream achieved by the Ube membrane and the Generon® membrane.

| | CO₂ | CO | CH₄ | Ar/N₂ | H₂ | H₂S | H₂O |
|---|---|---|---|---|---|---|---|
| | conc. | conc. | conc. | conc. | conc. | conc. | conc. |
| Ube membrane | | | | | | | |
| Cooled syngas Feed, 20° C. | 2.88% | 23.98% | 0.96% | 0.20% | 71.93% | 0.00% | 0.05% |
| First CO-rich stream, 20° C. | 3.82% | 56.80% | 2.38% | 0.48% | 36.52% | 0.00% | 0.00% |
| Second H₂-rich stream, 20° C. | 2.26% | 2.25% | 0.02% | 0.02% | 95.37% | 0.00% | 0.08% |
| Cooled syngas Feed, 30° C. | 2.88% | 23.97% | 0.96% | 0.20% | 71.90% | 0.00% | 0.09% |
| First CO-rich stream, 30° C. | 3.86% | 67.06% | 2.88% | 0.57% | 25.63% | 0.00% | 0.00% |
| Second H₂-rich stream, 30° C. | 2.41% | 3.19% | 0.04% | 0.02% | 94.21% | 0.00% | 0.13% |
| Cooled syngas Feed, 40° C. | 2.88% | 23.96% | 0.96% | 0.20% | 71.88% | 0.00% | 0.12% |
| First CO-rich stream, 40° C. | 3.83% | 64.90% | 2.84% | 0.56% | 27.87% | 0.00% | 0.01% |
| Second H₂-rich stream, 40° C. | 2.41% | 4.09% | 0.05% | 0.02% | 93.25% | 0.00% | 0.17% |
| Cooled syngas Feed, 50° C. | 2.87% | 23.92% | 0.96% | 0.20% | 71.76% | 0.00% | 0.29% |
| First CO-rich stream, 50° C. | 4.04% | 70.87% | 3.14% | 0.61% | 21.33% | 0.00% | 0.01% |
| Second H₂-rich stream, 50° C. | 2.39% | 4.55% | 0.06% | 0.03% | 92.56% | 0.00% | 0.41% |
| Generon membrane | | | | | | | |
| Cooled syngas Feed, 38° C. | 2.87% | 23.99% | 0.97% | 0.19% | 71.97% | 0.00% | 0.01% |
| First CO-rich stream, 38° C. | 2.93% | 89.53% | 3.88% | 0.76% | 2.90% | 0.00% | 0.00% |
| Second H₂-rich stream, 38° C. | 2.85% | 5.42% | 0.15% | 0.03% | 91.54% | 0.00% | 0.01% |
| Cooled syngas Feed, 38° C. | 2.87% | 23.99% | 0.97% | 0.19% | 71.97% | 0.00% | 0.01% |
| First CO-rich stream, 38° C. | 3.02% | 73.49% | 2.93% | 0.58% | 19.98% | 0.00% | 0.00% |
| Second H₂-rich stream, 38° C. | 2.81% | 3.26% | 0.15% | 0.03% | 93.74% | 0.00% | 0.13% |
| Cooled syngas Feed, 38° C. | 2.87% | 23.99% | 0.97% | 0.19% | 71.97% | 0.00% | 0.01% |
| First CO-rich stream, 38° C. | 3.28% | 67.29% | 2.69% | 0.53% | 26.21% | 0.00% | 0.00% |
| Second H₂-rich stream, 38° C. | 2.67% | 2.83% | 0.13% | 0.02% | 94.34% | 0.00% | 0.01% |
| Cooled syngas Feed, 57° C. | 2.87% | 23.99% | 0.97% | 0.19% | 71.97% | 0.00% | 0.01% |
| First CO-rich stream, 57° C. | 3.74% | 59.84% | 2.51% | 0.49% | 33.42% | 0.00% | 0.00% |
| Second H₂-rich stream, 57° C. | 2.38% | 3.69% | 0.10% | 0.02% | 93.79% | 0.00% | 0.02% |

### Example 6

The present inventor initiated a study to compare membrane performance of an Ube commercial membrane (at 40° C.) and a Generon commercial membrane (at 38° C.) in separating a syngas. The mixed gas selectivity of these membranes was compared for mixed gas H₂/CO₂ (shifted syngas) vs. mixed gas H₂/CO separations (unshifted syngas).

### Membrane Performance Comparison on Unshifted and Shifted Syngas:

As can be seen from the above table, H₂/CO mixed gas selectivity in the Ube and Generon commercial gas separation membranes for separating unshifted syngas is substantially higher than their H₂/CO₂ mixed gas selectivity for separating shifted syngas. The increase in mixed gas selectivity is greater by more than an order of magnitude, enabling higher recoveries and purities in unshifted syngas for the respective separated gases.

As an example, for a given unshifted syngas feed composition, the Ube membrane recovers 87.3% of the H₂ at 93.3% purity in the permeate and 88.5% of the CO at 64.9% purity in the retentate. In contrast, for a given shifted syngas feed composition, the Ube membrane recovers 89.2% of the H₂ at 82.8% purity in the permeate and 45.1% of the CO₂ at 52.2% purity in the retentate.

As another example, for a given unshifted syngas feed composition, the Generon® membrane recovers 91.8% of the H₂ at 93.7% purity in the permeate and 90.4% of the CO at 73.5% purity in the retentate. In contrast, for a given shifted syngas feed composition, the Generon membrane recovers 91.8% of the H₂ at 79.1% purity in the permeate and 28.1% of the CO₂ at 45.9% purity in the retentate.

The above comparisons are presented in the table below:

| | retentate | | permeate | |
|---|---|---|---|---|
| | H₂ rec. | H₂ purity | CO rec. | CO purity |
| Ube unshifted syngas | 87.3% | 93.3% | 88.5% | 64.9% |
| Generon ® unshifted | 91.8% | 93.7% | 90.4% | 73.5% |
| syngas | | | | |
| | H₂ rec. | H₂ purity | CO₂ rec. | CO₂ purity |
| Ube shifted syngas | 89.2% | 82.8% | 45.1% | 52.2% |
| Generon ® shifted | 91.8% | 79.1% | 28.1% | 45.9% |
| syngas | | | | |

The recoveries and purities of the separated CO₂ from shifted syngas is substantially lower than the recoveries and purities of the separated CO from unshifted syngas.

1. A process comprising:
a. feeding natural gas from a first natural gas source to syngas converting means for converting natural gas to syngas,
b. feeding a separator feedstream comprising the syngas to membrane separator means,
c. separating the separator feedstream in the separator means to form a first, CO-rich stream and a second, H₂-rich stream,
d. feeding the first, CO-rich stream as an oxyfuel combustor feedstream to oxyfuel combustor means for forming sub-critical CO₂ gas turbine working fluid, and
e. feeding the sub-critical CO₂ gas turbine working fluid to gas turbine means for producing power,
f. wherein the sub-critical CO₂ gas turbine working fluid exits the gas turbine means as gas turbine exhaust which is fed to heat recovery steam generator means for generating steam, and wherein steam from the heat recovery steam generator means is fed as first steam working fluid to first steam turbine means for generating power,
g. wherein at least a first portion of exhaust from the gas turbine is recycled as feed to the oxyfuel combustor means together with high purity oxygen and the first, CO-rich stream,
h. wherein the second, H₂-rich stream is fed as an air-fuel combustor feedstream to air-fuel combustor means for forming air-fuel gas turbine working fluid, and wherein the air-fuel gas turbine working fluid is fed to air-fuel gas turbine means for producing power, and
i. wherein supplemental natural gas is added to the first, CO-rich stream.

2. The process of claim 1, wherein the supplemental natural gas is added as a slip stream from the first natural gas source.

3. The process of claim 1, wherein the supplemental natural gas is fed from a second natural gas source.

4. The process of claim 1, wherein the supplemental natural gas is also added to the second, H₂-rich stream.

5. The process of claim 2, wherein the supplemental natural gas is also added to the second, H₂-rich stream.

6. The process of claim 3, wherein the supplemental natural gas is fed from a second natural gas source.

7. A process comprising:
a. feeding natural gas from a first natural gas source to syngas converting means for converting natural gas to syngas,
b. feeding a separator feedstream comprising syngas from natural gas to separator means,
a. separating the separator feedstream in the separator means to form a first, CO-rich stream and a second, H₂-rich stream,
c. feeding the first, CO-rich stream as an oxyfuel combustor feedstream to oxyfuel combustor means for forming sub-critical CO₂ gas turbine working fluid,
d. feeding the sub-critical CO₂ gas turbine working fluid to sub-critical CO₂ gas turbine means, the sub-critical CO₂ gas turbine means having a sub-critical CO₂ gas turbine expansion section and a sub-critical CO₂ gas turbine compression section, the sub-critical CO₂ gas turbine working fluid being fed to the sub-critical CO₂ gas turbine expansion section for producing power,
e. recycling at least a first portion of exhaust from the sub-critical CO₂ gas turbine expansion section together with high purity oxygen to the sub-critical CO₂ gas turbine compression section of the sub-critical CO₂ gas turbine means, wherein the power produced in step (d) is used to power the sub-critical CO₂ gas turbine compression section to compress the recycled sub-critical CO₂ gas turbine exhaust,
f. capturing the remaining portion of sub-critical CO₂ gas turbine exhaust,
g. feeding the compressed sub-critical CO₂ gas turbine exhaust to the oxyfuel combustor means,
h. reacting the first, CO-rich stream with high purity oxygen in the oxyfuel combustor means under sub-critical CO₂ conditions,
i. feeding the second, H₂-rich stream as an air-fuel combustor feedstream to air-fuel combustor means wherein the air-fuel combustor feedstream is reacted with air to form an air-fuel gas turbine working fluid,
j. feeding the air-fuel gas turbine working fluid to air-fuel gas turbine means, the air-fuel gas turbine means having an air-fuel gas turbine expansion section and an air-fuel gas turbine compression section, the air-fuel gas turbine working fluid being fed to the of air-fuel gas turbine expansion section for producing power,
k. feeding air to the air-fuel gas turbine compression section of the air-fuel gas turbine means, wherein the air is compressed using the power produced in step (j),
l. feeding the compressed air to the air-fuel combustor means for reaction with the second, H₂-rich stream to form the air-fuel gas turbine working fluid,
m. wherein before recycling exhaust from the sub-critical CO₂ gas turbine expander section to the sub-critical CO₂ gas turbine compression section of the sub-critical CO₂ gas turbine means, the exhaust is fed to first heat recovery steam generator means for generating steam,
n. wherein steam from the first heat recovery steam generator means is fed to first steam turbine means for generating power,
o. wherein exhaust from the air-fuel gas turbine means is fed to second heat recovery steam generator means for generating steam,
p. wherein steam from the second heat recovery steam generator means is fed to second steam turbine means for generating power. and
q. wherein supplemental natural gas is added to the first, CO-rich stream.

8. The process of claim 7, wherein the supplemental natural gas is added as a slip stream from the first natural gas source.

9. The process of claim 7, wherein the supplemental natural gas is fed from a second natural gas source.

10. The process of claim 7, wherein the supplemental natural gas is also added to the second, H₂-rich stream.

11. The process of claim 8, wherein the supplemental natural gas is also added to the second, H₂-rich stream.

12. process of claim 9, wherein the supplemental natural gas is also added to the second, H₂-rich stream.

13. The process of claim 1, wherein the first, CO-rich stream is fed directly to the oxyfuel combustor means.

14. The process of claim 7, wherein the first, CO-rich stream is fed directly to the oxyfuel combustor means.

15. A process comprising:
a. feeding a separator feedstream comprising syngas from natural gas to membrane separator means,
b. separating the separator feedstream in the separator means to form a first, CO-rich stream and a second, H₂-rich stream,
c. feeding the first, CO-rich stream as an oxyfuel combustor feedstream to oxyfuel combustor means for forming sub-critical CO₂ gas turbine working fluid, and
d. feeding the sub-critical CO₂ gas turbine working fluid to gas turbine means for producing power,
e. wherein the sub-critical CO₂ gas turbine working fluid exits the gas turbine means as gas turbine exhaust which is fed to heat recovery steam generator means for generating steam, and wherein steam from the heat recovery steam generator means is fed as first steam working fluid to first steam turbine means for generating power,
f. wherein at least a first portion of exhaust from the gas turbine is recycled as feed to the oxyfuel combustor means together with high purity oxygen and the CO-rich stream,
g. wherein the second, H₂-rich stream is fed as a H₂ feedstream to treatment means for increasing the H₂ purity of the H₂ feedstream, and
h. wherein supplemental natural gas is added to the first, CO-rich stream.

16. The process of claim 15, wherein the supplemental natural gas is added as a slip stream from the first natural gas source.

17. The process of claim 15, wherein the supplemental natural gas is fed from a second natural gas source. The process of claim 15, wherein the supplemental natural gas is also added to the second, H₂-rich stream.

18. The process of claim 16, wherein the supplemental natural gas is also added to the second, H₂-rich stream.

19. The process of claim 17, wherein the supplemental natural gas is also added to the second, H₂-rich stream.
